(19) United States
(12) Patent Application Publication
(10) Pub. No.: US 2026/0048713 A1
(43) Pub. Date: Feb. 19, 2026

(54) VEHICLE INTERFACE USING GENERATIVE ARTIFICIAL INTELLIGENCE

(71) Applicant: Rivian IP Holdings, LLC, Irvine, CA (US)

(72) Inventors: Dhruv MEHTA, Hoffman Estates, IL (US); Christopher Marshall JACOBS, Palo Alto, CA (US); Fateh BENMERZOUG, Irvine, CA (US); Pranil VORA, Irvine, CA (US); Jason SHIVERICK, San Francisco, CA (US); Patrick HARRINGTON, Asheville, NC (US); Derek Joe Wai HO, Vancouver (CA); Pramod IMMANENI, Irvine, CA (US)

(21) Appl. No.: 19/293,523

(22) Filed: Aug. 7, 2025

Related U.S. Application Data
(60) Provisional application No. 63/683,089, filed on Aug. 14, 2024.

(51) Int. Cl. B60R 16/037; B60K 35/10; B60K 35/29

(52) U.S. Cl. CPC B60R 16/0373; B60K 35/10; B60K 35/29; B60K 2360/148

(57) ABSTRACT

A computing system receives text from a vehicle and receives a vehicle state from the vehicle. The computing system composes a prompt including the text, at least a portion of the vehicle state, and an instruction set. The computing system submits the prompt to a machine learning model and receives a response to the prompt from the machine learning model, the response including a selected instruction from the instruction set. The computing system transmits the selected instruction to the vehicle.

### RELATED APPLICATION

This application claims the benefit of U.S. Provisional Application Ser. No. 63/683,089 filed Aug. 14, 2024, and entitled VEHICLE INTERFACE USING GENERATIVE ARTIFICIAL INTELLIGENCE.

### INTRODUCTION

The present disclosure relates to using a cloud LLM to access functionality of a vehicle.

### SUMMARY

In one aspect, a computing system is configured to receive text from a vehicle and receive a vehicle state from the vehicle. The computing system composes a prompt including the text, at least a portion of the vehicle state, and an instruction set. The computing system submits the prompt to a machine learning model and receives a response to the prompt from the machine learning model, the response including a selected instruction from the instruction set. The computing system transmits the selected instruction to the vehicle.

In some embodiments, the response to the prompt includes one or more arguments for the selected instruction, the computing system configured to transmit the selected instruction to the vehicle with the one or more arguments.

In some embodiments, the at least the portion of the vehicle state is a portion of the vehicle state. The computing system is configured to select the portion of the vehicle state according to relevance to the text.

In some embodiments, the computing system is configured to select the instruction set according to relevance to the text.

In some embodiments, the machine learning model is a large language model (LLM).

In some embodiments, the vehicle state includes a state of charge of a battery of the vehicle.

In some embodiments, the vehicle state includes a state of a climate control system of the vehicle.

In some embodiments, the computing system is a cloud computing platform.

In another aspect, a method includes receiving, by a computing system, text from a vehicle and receiving, by the computing system, a vehicle state from the vehicle. The method includes composing, by the computing system, a prompt including the text, at least a portion of the vehicle state, and an instruction set. The method includes submitting, by the computing system, the prompt to a machine learning model. The method includes receiving, by the computing system, a response to the prompt from the machine learning model, the response including a selected instruction from the instruction set. The method includes transmitting, by the computing system, the selected instruction to the vehicle.

In some embodiments, the response to the prompt includes one or more arguments for the selected instruction, the computing system configured to transmit the selected instruction to the vehicle with the one or more arguments.

In some embodiments, the at least the portion of the vehicle state is a portion of the vehicle state. The method may further include selecting, by the computing system, the portion of the vehicle state according to relevance to the text.

In some embodiments, the method includes selecting, by the computing system, the instruction set according to relevance to the text.

In some embodiments, the machine learning model is a large language model (LLM).

In some embodiments, the vehicle state includes a state of charge of a battery of the vehicle.

In some embodiments, the vehicle state includes a state of a climate control system of the vehicle.

In another aspect, a vehicle includes a plurality of components, a microphone, and a computing system. The computing system is configured to detect speech in an output of the microphone and generate a context relevant to the speech, the context including a state of one or more components of the plurality of components. The computing system transmits a request to a remote computing system, the request including the speech and the context. The computing system may receive a response to the request from the remote computing system. The computing system executes an instruction included in the response with respect to the one or more components.

In some embodiments, the computing system is configured to convert the speech to text.

In some embodiments, the one or more components include a climate control system of the vehicle and the context includes a state of the climate control system.

In some embodiments, the one or more components include a climate control system of the vehicle and the context includes a state of the climate control system.

In some embodiments, a computing system is configured to generate a response to a request from a vehicle, the response including text. The computing system is configured to detect connectivity to the vehicle. When the connectivity to the vehicle has first quality, the computing system synthesizes the response to generate an audio message and transmits the audio message to the vehicle. When the connectivity to the vehicle has a second quality less than the first quality, the computing system transmits the response to the vehicle without synthesizing the response to generate the audio message.

### BRIEF DESCRIPTION OF THE DRAWINGS

FIG. 1A illustrates an example vehicle that may be operated in accordance with certain embodiments.

FIG. 1B illustrates a chassis of a vehicle having multiple drive units that may be operated in accordance with certain embodiments.

FIG. 2 is a schematic block diagram of components for operating the vehicle in accordance with certain embodiments.

FIG. 3 is schematic block diagram illustrating a system for implementing a voice assistant in a vehicle in accordance with certain embodiments.

FIG. 4 is a process flow diagram of a method for implementing a voice assistant in a vehicle in accordance with certain embodiments.

FIG. 5 is schematic diagram illustrating control of voice quality based on network connection quality in accordance with certain embodiments.

### DETAILED DESCRIPTION

Large language models (LLMs) have the ability to provide responses to natural language queries in the form of natural language outputs. Although commercially available LLMs are very sophisticated in understanding and generating text, the training of LLMs is often very general, such that the ability of an LLM to provide accurate domain-specific responses is limited. Using the approach described herein, a vehicle in combination with a cloud agent interfacing with an LLM are able to use the capabilities of an LLM to provide voice-controlled functions on the vehicle.

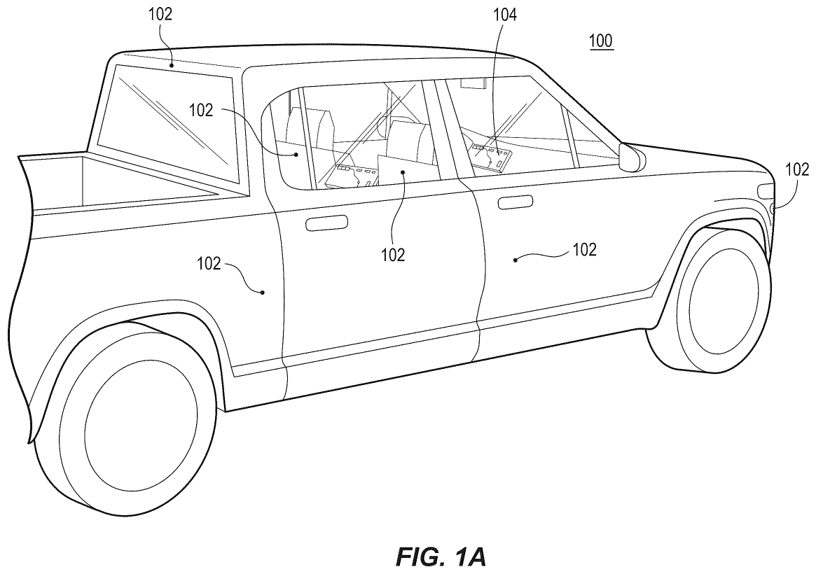

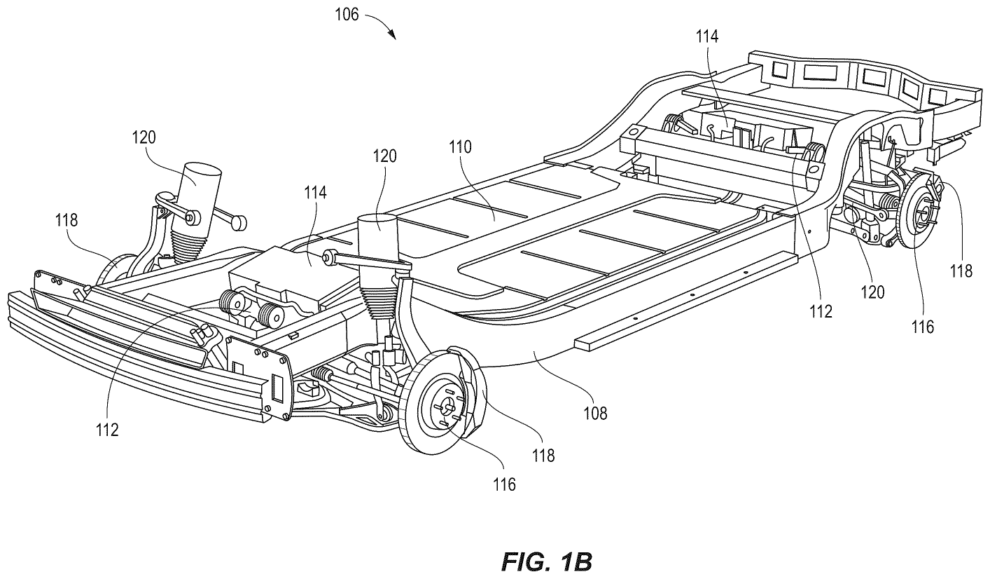

FIG. 1A illustrates an example vehicle 100 in which the approach described herein may be implemented. As seen in FIG. 1A, the vehicle 100 has multiple exterior cameras 102 and one or more front displays 104. Each of these exterior cameras 102 may capture a particular view or perspective on the outside of the vehicle 100. The images or videos captured by the exterior cameras 102 may then be presented on one or more displays in the vehicle 100, such as the one or more front displays 104, for viewing by a driver.

Referring to FIG. 1B, the vehicle 100 may include a chassis 106 including a frame 108 providing a primary structural member of the vehicle 100. The frame 108 may be formed of one or more beams or other structural members or may be integrated with the body of the vehicle (e.g., unibody construction).

In embodiments where the vehicle 100 is a battery electric vehicle (BEV) or possibly a hybrid vehicle, a large battery 110 is mounted to the chassis 106 and may occupy a substantial (e.g., at least 80 percent) of an area within the frame 108. For example, the battery 110 may store from 100 to 200 kilowatt hours (kWh). The battery 110 may be a lithium-ion battery or other type of rechargeable battery. The battery may be substantially planar in shape.

Power from the battery 110 may be supplied to one or more drive units 112. Each drive unit 112 may be formed of an electric motor and possibly a gear train providing a gear reduction. In some embodiments, there is a single drive unit 112 driving either the front wheels or the rear wheels of the vehicle 100. In another embodiment, there are two drive units 112, each driving either the front wheels or the rear wheels of the vehicle 100. In yet another embodiment, there are four drive units 112, each drive unit 112 driving one of four wheels of the vehicle 100.

Power from the battery 110 may be supplied to the drive units 112 by one or more sets of power module 114, such as power module for each drive unit 112 or pair of drive units 112. The power module 114 may include inverters configured to convert direct current (DC) from the battery 110 into alternating current (AC) supplied to the motors of the drive units 112. The power module 114 further facilitate operation of the motors of the drive units as generators to provide regenerative braking. The power module 114 further facilitate the transfer of regenerative current to the battery 110.

The drive units 112 are coupled to two or more hubs 116 to which wheels may mount. Each hub 116 includes a corresponding brake 118, such as the illustrated disc brakes. Each hub 116 is further coupled to the frame 108 by a suspension 120. The suspension 120 may include metal or pneumatic springs for absorbing impacts. The suspension 120 may be implemented as a pneumatic or hydraulic suspension capable of adjusting a ride height of the chassis 106 relative to a support surface. The suspension 120 may include a damper with the properties of the damper being either fixed or adjustable electronically.

In the embodiment of FIGS. 1B and 1n the discussion below, the vehicle 100 is a battery electric vehicle. However, a hybrid-electric vehicle may also benefit from the approach described herein. Likewise, non-vehicular applications that use an inverter or other relevant power component may also benefit from the approach described herein.

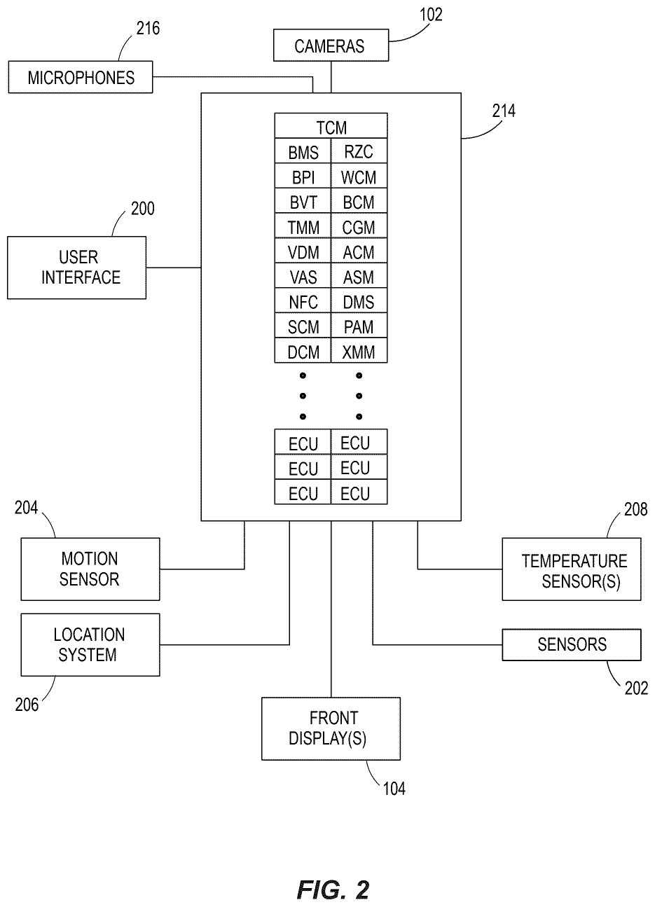

FIG. 2 illustrates example components of the vehicle 100 of FIG. 1A. As seen in FIG. 2, the vehicle 100 includes the cameras 102, the one or more front displays 104, a user interface 200, one or more sensors 202, a motion sensor 204, and a location system 206. The one or more sensors 202 may include ultrasonic sensors, radio detection and ranging (RADAR) sensors, light detection and ranging (LIDAR) sensors, or other types of sensors. The location system 206 may be implemented as a global positioning system (GPS) receiver. The user interface 200 allows a user, such as a driver or passenger in the vehicle 100, to provide input.

The components of the vehicle 100 may include one or more temperature sensors 208. The temperature sensors 208 may include sensors configured to sense an ambient air temperature, temperature of the battery 110, temperature of a power module 114, temperature of each drive unit 112 and/or each motor of each drive unit 112, temperature of coolant fluid entering or leaving a coolant system, temperature of oil within a drive unit 112, or the temperature of any other component of the vehicle 100. The temperature sensors 208 may include a temperature sensor directly mounted to a microprocessor of the power module 114 as described in greater detail below.

A control system 214 executes instructions to perform at least some of the actions or functions of the vehicle 100. For example, as shown in FIG. 2, the control system 214 may include one or more electronic control units (ECUs) configured to perform at least some of the actions or functions of the vehicle 100, including the functions described below. In certain embodiments, each of the ECUs is dedicated to a specific set of functions.

Certain features of the embodiments described herein may be controlled by a Telematics Control Module (TCM) ECU. The TCM ECU may provide a wireless vehicle communication gateway to support functionality such as, by way of example and not limitation, over-the-air (OTA) software updates, communication between the vehicle and the internet, communication between the vehicle and a computing device, in-vehicle navigation, vehicle-to-vehicle communication, communication between the vehicle and landscape features (e.g., automated toll road sensors, automated toll gates, power dispensers at charging stations), or automated calling functionality.

Certain features of the embodiments described herein may be controlled by a Central Gateway Module (CGM) ECU. The CGM ECU may serve as the vehicle's communications hub that connects and transfer data to and from the various ECUs, sensors, cameras, microphones, motors, displays, and other vehicle components. The CGM ECU may include a network switch that provides connectivity through Controller Area Network (CAN) ports, Local Interconnect Network (LIN) ports, and Ethernet ports. The CGM ECU may also serve as the master control over the different vehicle modes (e.g., road driving mode, parked mode, off-roading mode, tow mode, camping mode), and thereby control certain vehicle components related to placing the vehicle in one of the vehicle modes.

In various embodiments, the CGM ECU collects sensor signals from one or more sensors of vehicle 100. For example, the CGM ECU may collect data from cameras 102, sensors 202, motion sensor 204, location system 206, and temperature sensors 208. The sensor signals collected by the CGM ECU are then communicated to the appropriate ECUs for processing.

The control system 214 may also include one or more additional ECUs, such as, by way of example and not limitation: a Vehicle Dynamics Module (VDM) ECU, an Experience Management Module (XMM) ECU, a Vehicle Access System (VAS) ECU, a Near-Field Communication (NFC) ECU, a Body Control Module (BCM) ECU, a Seat Control Module (SCM) ECU, a Door Control Module (DCM) ECU, a Rear Zone Control (RZC) ECU, an Autonomy Control Module (ACM) ECU, an Autonomous Safety Module (ASM) ECU, a Driver Monitoring System (DMS) ECU, and/or a Winch Control Module (WCM) ECU.

If vehicle 100 is an electric vehicle, one or more ECUs may provide functionality related to the battery pack of the vehicle, such as a Battery Management System (BMS) ECU, a Battery Power Isolation (BPI) ECU, a Balancing Voltage Temperature (BVT) ECU, and/or a Thermal Management Module (TMM) ECU. In various embodiments, the XMM ECU transmits data to the TCM ECU (e.g., via Ethernet, etc.). Additionally or alternatively, the XMM ECU may transmit other data (e.g., sound data from microphones 216, etc.) to the TCM ECU.

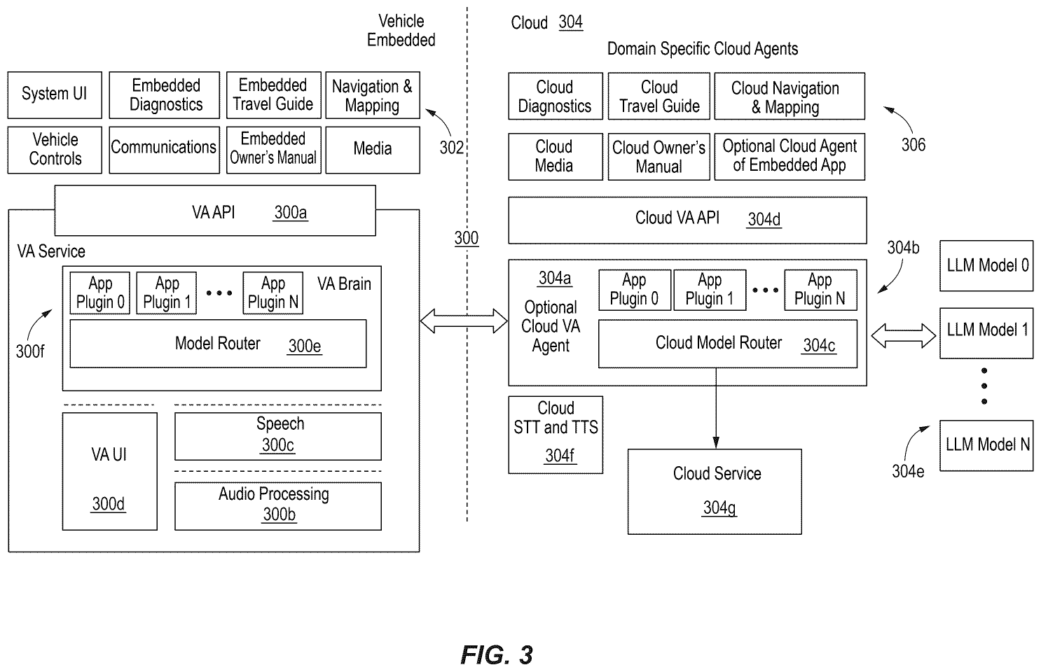

Referring to FIG. 3, the control system 214 may execute a voice assistant (VA) service 300 (“the service 300”). The VA service 300 includes an application programming interface (API) 300a for interfacing with various components of the control system 214 and other components 302 of the vehicle, such as those illustrated or any of the ECUs of FIG. 2. The API 300a may enable the service 300 to control the components and to receive and react to events generated by the other components.

The service 300 may include an audio processing module 300b that receives the output of a microphone and performs audio processing to facilitate interpretation of spoken words in the output of the microphone. The audio processing module 300b may perform the illustrated function and produce a processed output. A speech model 300c receives the processed output and attempts to detect spoken words in the processed output. The speech model 300c may remain inactive other than attempting to detect a wake word (e.g., “OK, Rivian”) in the processed output. Upon detecting the wake word, the speech model 300c may perform other processing, such as speech to text (STT). The speech model 300c may also convert text to be output to a user into synthesized speech that is output on a speaker, e.g., text to speech (TTS).

The service 300 may include a user interface module 300d that receives inputs by way of interfaces displayed on a front display 104 and displays outputs generated by the service 300 on the front display 104. Information described herein as being output by speakers may be supplemented with information displayed on a front display 104, including user interface elements for invoking functionality of the vehicle 100.

The service 300 may include a router 300e. The router 300e routes events to one or more application plugins 300f. For example, the events may be speech detected using the speech model 300c and routed to plugins 300f according to keywords included in the speech. Events may be events generated by a vehicle component 302. Events may include data received from a cloud 304 as discussed below. Application plugin 300f may further generate events that are processed by another application plugin 300f.

Application plugins 300f may receive speech (e.g., text generated from speech) detected using the speech model 300c and receive a state of the vehicle 100 from one or more vehicle components 302 and generate a request that is sent to the cloud 304. The request may include the speech and a context. The context may include a portion of the vehicle state determined by the application plugin 300f to be relevant to the speech. For example, a request including speech (e.g., text derived from speech or an audio signal including the speech) that references the climate in a cabin of the vehicle may include a context reflecting a current state of the climate control system of the vehicle 100.

In the cloud 304, a voice assistant agent 304a may interface with the service 300 and receive requests generated by the service 300 and produce responses to the requests. The voice assistant agent 304a may include various application plugins 304b that process events, such as requests. The application plugins 304b may receive events by way of a cloud router 304c that routes events to application plugins 304b that are addressed by the events or that are registered to receive events of a particular type. The application plugins 304b may further generate events that are processed by other application plugins 304b.

The voice assistant agent 304a may interface with software components 306 that are executing in the cloud 304 or are otherwise accessible by way of the cloud 304. The software components 306 may include specialized logic for diagnosing components 302 of the vehicle 100. The software components 306 may also provide responses to different types of queries, such as navigation, providing travel guide functions, or other functions.

The voice assistant agent 304a may interface with the software components 306 by way of a cloud API 304d. The software components 306 may generate events that are sent to the voice assistant agent 304a by way of the cloud API 304d.

The application plugins 304b may submit prompts to a large language model (LLM) 304e or other generative artificial intelligence platform. The LLM 304e may include any commercially available LLM (GOOGLE GEMINI, OPENAI's CHATGPT, MICROSOFT COPILOT) or a proprietary LLM. The voice assistant agent 304a may function regardless of the LLM 304e that is used. The application plugins 304b may receive a response to a prompt as an event and process the event, such as by submitting the response to a software component 306. For example, the prompt may include speech and a context from a request received from the service 300 along with text that instructs the LLM 304e to generate an appropriate instruction for a software component 306 based on the speech, the context and possibly an instruction set for the software component 306 from which to select the instruction.

The cloud 304 may execute cloud audio processing functions 304f, such as STT and TTS. For example, where a connection has sufficient bandwidth, a request may include an audio segment rather than text such that the cloud audio processing functions 304f translate the audio segment into text. The cloud audio processing functions 304f may additionally convert a text response generated by an application plugin 304b into an audio segment that may be transmitted to the service 300 for playback on cabin speakers of the vehicle 100.

The application plugins 304b may additionally interface with cloud services 304g, such as third-party services including GOOGLE MAPS, streaming music services (e.g., SPOTIFY), dining reservation service (e.g., OPEN TABLE), or the like.

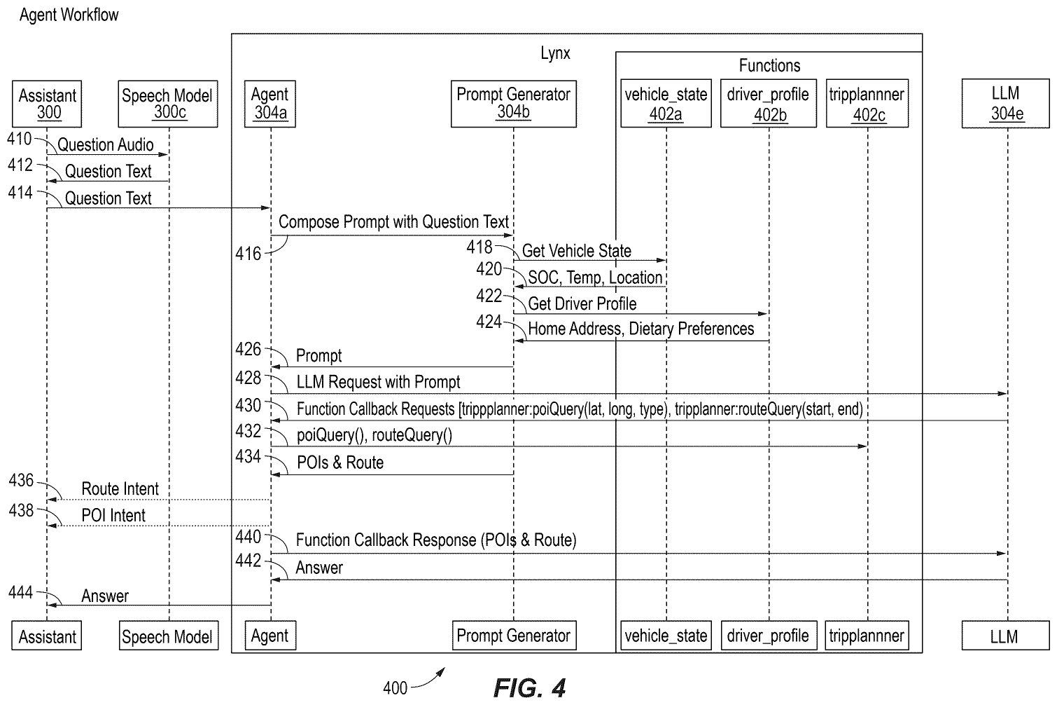

FIG. 4 illustrates a method 400 that may be performed in order to process voice inputs received from a user of the vehicle 100. Question audio is received at step 410, such as from a microphone and the audio processing module 300b. The question audio is processed at step 412 to obtain question text, such as by the speech model 300c or the cloud audio processing functions 304f.

At step 414, the question text may be transmitted to the voice assistant agent 304a in the cloud 304. Step 414 may be preceded by, or accompanied by, transmitting a vehicle state to the voice assistant agent 304a. For example, while connected to the cloud 304, the control system 214 may maintain current a vehicle state 402a stored in the cloud 304. The vehicle state 402a may include the output of any sensors of the vehicle (see FIG. 2 and corresponding description), a state of any of the ECUs of the vehicle, a location of the vehicle, an environment of the vehicle (e.g., temperature, output of rain sensor, output of a light sensor, etc.), a velocity of the vehicle, a current driving state (stopped, in park, driving, drive mode, etc.).

The voice assistant agent 304a may request generation of a prompt by a prompt generator 304b, which may be one of the application plugins 304b selected based on a type of the request, the keywords included in the question text, the application plugin 300f that generated the request, or other criteria. The prompt generator 304b may generate the prompt at step 416. Generating the prompt may include requesting contextual information to generate the prompt. For example, the prompt generator 304b may request, at step 418, the current vehicle state 402a and receive at least a portion of the current vehicle state 402a at step 6. Step 418 may include requesting a portion of the vehicle state 402a, e.g., a portion relevant to the question text, which is then received at step 420. In the illustrated example, the vehicle state includes a state of charge (SOC), temperature, and geographic location. Relevance may include belonging to a same domain of information of a plurality of domains that corresponds to the question text. A domain may be selected due to textual similarity of a description of the domain to the question text using any approach for determining textual similarity.

At step 422, the prompt generator 304b may request a driver profile 402b and receive the driver profile at step 424. For example, the driver profile may include a home address, dietary preferences, or other attributes or preferences of a driver of the vehicle 100. In some embodiments, the prompt generator 304b may request information from a trip planner 402c.

The prompt generator 304b combines the question text and some or all of the information obtained at steps 420 and 424 into a prompt. For example, the prompt generator 304b may extract portions of the information obtained at steps 420 and 424 that are relevant to the question text. Relevance may be determined using any approach for determining relevance of one text (e.g., a data object including the information obtained at steps 420 and 424) and another text (e.g., the question text). The prompt may additionally include an instruction set, such as an instruction set relevant to the question text. Relevance of the instruction set may include performing a textual comparison of the question text to the instruction set, descriptions of the instruction set or individual instructions of the instruction set, or other data.

The instruction set may include, for example, function calls of an application programming interface (API) of the control system 214 for controlling a component of the vehicle, such as the climate control system, the drive train of the vehicle (e.g., function calls to select a drive mode, adjust the suspensions 120), an infotainment system of the vehicle (e.g., function calls for interfacing with navigation software, controlling playback of media, looking up point of interest (POI) information, etc.).

The prompt generator 304b may return the prompt to the voice assistant agent 304a at step 426, which may then transmit the prompt to the LLM 304e at step 428. A response to the prompt is received at step 430. An instruction included in the response to the prompt may be executed at step 432. For example, the LLM may select an instruction from the instruction set. The instruction may include arguments that may likewise be selected by the LLM 304e. For example, the prompt may list and/or describe possible arguments for instructions in the instruction set and the prompt may instruct the LLM to select arguments for an instruction selected by the LLM 304e.

The voice assistant agent 304a may then submit, at step 432, the instruction to a vehicle component 302 corresponding to the instruction, to a software component 306 in the cloud referenced by the instruction, or other component. For example, the cloud router 304c of the voice assistant agent 304a may route the instruction to the component referenced by the instruction. In the illustrated example, the instruction is provided to a trip planner 402c, which returns, at step 434, one or more points of interest (POI) and a route to a destination referenced by the instruction.

The response from the component may be an intent that may be processed in various ways, including invoking generation of another prompt to the LLM 304e. For example, the result of the instruction may be returned to the service 300. For example, a response to the service 300 may indicate, at step 436, that the user has indicated intent to travel a route or may indicate, at step 438, user intent to look up a POI. The service 300 may receive a response from the user (e.g., selection of a route or selection of a POI) by way of a spoken response or an input to the user interface module 300d.

In response, the voice assistant agent 304a may transmit a callback response to the LLM 304e at step 440. The callback response may include the intents from steps 436 and/or 438. The LLM 304e may return an answer to the voice assistant agent 304a at step 442. The voice assistant agent 304a may synthesize the answer into a spoken response, such as using the speech model 300c and return the spoken response to the service 300 at step 18. The service 300 may then play back the spoken response using speakers of the vehicle 100.

In some embodiments, a result from an instruction (e.g., from a vehicle component 302 or a software component 306) may be passed to the LLM 304e to obtain a summary of the response and the summary may be returned to the user and played back by the speakers of the vehicle 100.

In some embodiments, the response from the LLM 304e for a prompt including a spoken question may be a request for additional information. The request for additional information may be by the voice assistant agent 304a to the service 300 either before or after being synthesized to a spoken message. The spoken message may be played back by speakers of the vehicle 100. A spoken response to the spoken message may be forwarded by the service 300 to the voice assistant agent 304a for passing to the LLM as additional context for the spoken question.

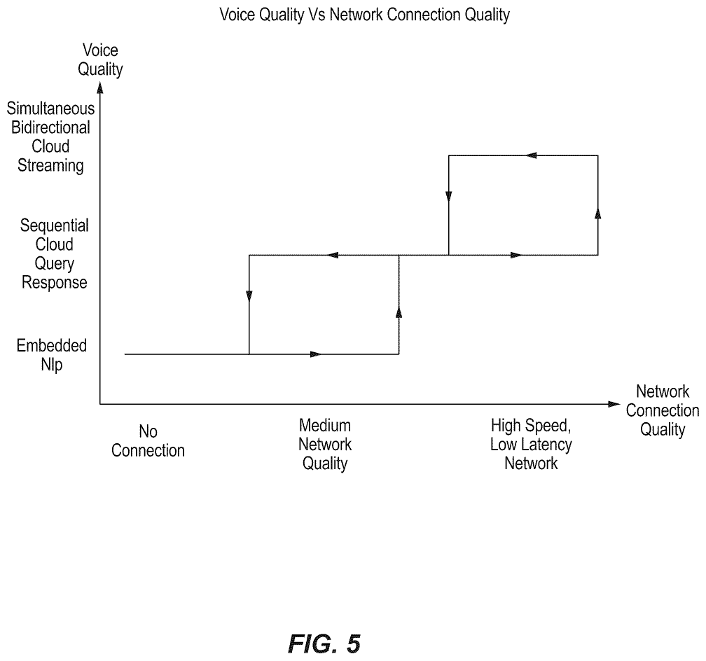

Referring to FIG. 5, the manner in which the voice assistant agent 304a interacts with the service 300 may correspond to the quality of a connection between the vehicle 100 and the cloud 304. For example, in the absence of a connection, the service 300 may process spoken questions by direct interpretation. For example, the spoken question may be converted to text and the text may matched against a fixed set of available commands. If a matching command is found, the command is executed. If a result of the command is a spoken response, the response is synthesized locally by the speech model 300c and played back on speakers of the vehicle 100.

Where a first level connectivity is available, the voice assistant agent 304a interacts with the service 300 using text and other data but any response from the LLM 304e or the voice assistant agent 304a is synthesized to speech locally by the speech model 300c and played back on speakers of the vehicle 100. The speech synthesized locally may be less realistic than speech synthesized by the cloud audio processing functions 304f. Features such as exhibiting emotion, variation in speed and volume, breath intakes, contextual emphasis, and the like may be present in speech synthesized by the cloud audio processing functions 304f but be absent in speech synthesized by the speech model 300c.

Where a second level of connectivity is available, the second level being greater than the first level, responses transmitted from the voice assistant agent 304a to the service 300 may be synthesized using the cloud audio processing functions 304f to obtain a spoken response and the spoken response may be transmitted to the service 300 for playback on the speakers of the vehicle 100. At the second level of connectivity, spoken questions may be transmitted by the service 300 to the voice assistant agent 304a as audio files that are converted to text using the cloud audio processing functions 304f, which may be more accurate. Spoken responses for the second level may be more conversational and include more information than spoken responses for the first level or where no connectivity is present.

As an example of the approach of FIG. 5. With no connectivity a user may be required to explicitly say “set the temperature to X degrees” in order to increase the set temperature of the climate control system. With the second level of connectivity, the user may simply say “I feel cold.” This statement may then be used to derive the user's intent to increase the set temperature of the climate control system.

With no connectivity, some functions may not be available. For example, commands that involve a software component 306 may not be available, such as advanced diagnostic functions. For example, error codes may be interpreted along with the vehicle state to provide a more verbose explanation of a problem whereas the service 300 alone may simply output an error code.

In some embodiments, the service 300 may implement a smaller and less capable LLM that processes spoken questions from a user that is used when there is no connectivity or the first level of connectivity. The service 300 may monitor a signal strength of a connection to the cloud 304 and switch between modes of operation (direct interpretation, first level functionality, second level functionality, etc.). In some embodiments, when connectivity is restored, a synchronization may occur wherein changes to the vehicle state and events that occurred during the loss of connectivity may be forwarded to the cloud 304 to update the vehicle state 402a. In some embodiments, where a loss of connectivity is expected (e.g., vehicle route passes through an area with no connectivity), data may be pushed by the voice assistant agent 304a to the service 300, such as road conditions, locations of charging stations, points of interest, locations of restaurants, or other data that may be relevant during the period of no connectivity.

The system described above may be used to implement various use cases. In a first example, an application plugin 300f may initiate creation of a spoken response using an LLM 304e. For example, creation of a prompt may be requested using the approach described above in response to an event generated by an application plugin 300f, such as in response to an event from a vehicle component 302 or a software component 306. For example, weather data may indicate snow is falling or is likely fall. The service 300 may invoke generation of a spoken response, e.g., “would you like to change to the snow and ice drive mode?” In another example, a vehicle state received by the voice assistant agent 304a may indicate that a first vehicle has encountered snowy or icy roads at a first location. In response, the voice assistant agent 304a may invoke playback of a question on a second vehicle 100 having a route passing through the first location, e.g., “Snow or ice expected ahead. Would you like to change to the snow and ice drive mode?”

In another example use case, the service 300 interacts with the voice assistant agent 304a to operate in a tour guide mode. For example, the user may ask “tell me about this location.” The vehicle's current location may be provided with the question text to the LLM in order to obtain a response that may then be synthesized and played back by the speakers of the vehicle 100.

In another example use case, the location of the vehicle 100 is detected to be within a threshold proximity of a house of the user and closer to a specific garage door of the user. The service 300 may invoke generation of a spoken question “would you like to open [garage door name]” and process any spoken response using the approach described above in order to invoke opening of the garage door.

In another example use case, a spoken user request is “open the frunk” and the vehicle state indicates a failed attempt to open the frunk. The vehicle state provided to the voice assistant agent 304a may be used to provide context to the LLM 304e when determining a response to the user request.

The descriptions of the various embodiments of the present disclosure have been presented for purposes of illustration. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure may exceed the specific described embodiments. Instead, any combination of the features and elements, whether related to different embodiments, is contemplated to implement and practice contemplated embodiments. Furthermore, although embodiments disclosed herein may achieve advantages over other possible solutions or over the prior art, the embodiments may achieve some advantages or no particular advantage. Thus, the aspects, features, embodiments and advantages discussed herein are merely illustrative.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a one or more computer processing devices. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Certain types of storage devices that include these mediums include: diskette, hard disk, random access memory (RAM), read only memory (ROM), erasable programmable read only memory (EPROM or Flash memory), static random access memory (SRAM), compact disc read only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, refers to non-transitory storage rather than transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but the storage device remains non-transitory during these processes because the data remains non-transitory while stored.

While the foregoing is directed to embodiments of the present disclosure, other and further embodiments may be devised without departing from the basic scope thereof, and the scope thereof is determined by the claims that follow.

What is claimed is:

1. A computing system configured to:
receive text from a vehicle;
receive a vehicle state from the vehicle;
compose a prompt including the text, at least a portion of the vehicle state, and an instruction set;
submit the prompt to a machine learning model;
receive a response to the prompt from the machine learning model, the response including a selected instruction from the instruction set; and
transmit the selected instruction to the vehicle.

2. The computing system of claim 1, wherein the response to the prompt includes one or more arguments for the selected instruction, the computing system further configured to transmit the selected instruction to the vehicle with the one or more arguments.

3. The computing system of claim 1, wherein the at least the portion of the vehicle state is a portion of the vehicle state, the computing system further configured to select the portion of the vehicle state according to relevance to the text.

4. The computing system of claim 3, wherein the computing system is configured to select the instruction set according to relevance to the text.

5. The computing system of claim 1, wherein the machine learning model is a large language model (LLM).

6. The computing system of claim 1, wherein the vehicle state includes a state of charge of a battery of the vehicle.

7. The computing system of claim 1, wherein the vehicle state includes a state of a climate control system of the vehicle.

8. The computing system of claim 1, wherein the computing system is a cloud computing platform.

9. A method comprising:
receiving, by a computing system, text from a vehicle;
receiving, by the computing system, a vehicle state from the vehicle;
composing, by the computing system, a prompt including the text, at least a portion of the vehicle state, and an instruction set;
submitting, by the computing system, the prompt to a machine learning model;
receiving, by the computing system, a response to the prompt from the machine learning model, the response including a selected instruction from the instruction set; and
transmitting, by the computing system, the selected instruction to the vehicle.

10. The method of claim 9, wherein the response to the prompt includes one or more arguments for the selected instruction, the computing system configured to transmit the selected instruction to the vehicle with the one or more arguments.

11. The method of claim 9, wherein the at least the portion of the vehicle state is a portion of the vehicle state, the method further comprising:
selecting, by the computing system, the portion of the vehicle state according to relevance to the text.

12. The method of claim 11, further comprising selecting, by the computing system, the instruction set according to relevance to the text.

13. The method of claim 9, wherein the machine learning model is a large language model (LLM).

14. The method of claim 9, wherein the vehicle state includes a state of charge of a battery of the vehicle.

15. The method of claim 9, wherein the vehicle state includes a state of a climate control system of the vehicle.

16. A vehicle comprising:
a plurality of components;
a microphone; and
a computing system configured to:
detect speech via the microphone;
generate a context relevant to the speech, the context including a state of one or more components of the plurality of components;
transmit a request to a remote computing system, the request including the speech and the context;
receive a response to the request from the remote computing system; and
execute an instruction included in the response with respect to the one or more components.

17. The vehicle of claim 16, wherein the computing system is configured to convert the speech to text.

18. The vehicle of claim 16, wherein the one or more components include a climate control system of the vehicle and the context includes a state of the climate control system.

19. The vehicle of claim 16, wherein the one or more components include a climate control system of the vehicle and the context includes a state of the climate control system.

20. The vehicle of claim 16, wherein the computing system is further configured to synchronize a state of the vehicle with the remote computing system.
